(19) United States
(12) Patent Application Publication
(10) Pub. No.: US 2026/0184539 A1
(43) Pub. Date: Jul. 2, 2026

(54) ELEVATOR SYSTEM

(71) Applicant: KONE Corporation, Helsinki (FI)

(72) Inventors: Xiaogeng ZHANG, Helsinki (FI); Jun WANG, Helsinki (FI); Hao WANG, Helsinki (FI); Yazhong MEI, Helsinki (FI)

(73) Assignee: KONE Corporation, Helsinki (FI)

(21) Appl. No.: 19/546,608

(22) Filed: Feb. 23, 2026

Related U.S. Application Data
(63) Continuation of application No. PCT/CN2024/102930, filed on Jul. 1, 2024.

(30) Foreign Application Priority Data
Aug. 24, 2023 (CN) 202311075563.2

(51) Int. Cl. B66B 7/04; B66B 11/00; B66B 11/04; B66B 19/00

(52) U.S. Cl. CPC B66B 7/047; B66B 11/0045; B66B 11/04; B66B 19/002

(57) ABSTRACT

An elevator system, including: an upright post, extending vertically along an elevator hoistway and accommodating a guide rail; and a guide shoe, for engaging the guide rail, during an installation of the elevator system via a traction device, the guide shoe is temporarily installed to the upright post via a fastening device to engage the guide rail.

### CROSS-REFERENCE TO RELATED APPLICATIONS

This application claims the priority of China application CN202311075563.2 filed in China National Intellectual Property Administration, China on Aug. 24, 2023.

### TECHNICAL FIELD

The present disclosure relates to an elevator system.

### BACKGROUND

In an installation process of an elevator system, a traction-type hoist, such as Tirak, is often needed, and is usually installed on a top beam of an elevator system. However, a machine such as Tirak is usually far from the top of the elevator car, for example, more than 1400 mm. Therefore, if the operator wants to stand on the top of the elevator car for installation operation, the operator may not be able to reach the Tirak machine. Therefore, an extra working platform is often needed for the operator to stand and install the remaining guide rail.

Therefore, there is a need for an elevator system, which can use the top of the elevator car as a working platform and save the need for an additional working platform.

### SUMMARY

The present disclosure provides an elevator system, which includes: an upright post, extending vertically along an elevator hoistway and accommodating a guide rail; and a guide shoe, for engaging the guide rail, which is characterized in that, during an installation of the elevator system via a traction device, the guide shoe is temporarily installed to the upright post via a fastening device to engage the guide rail.

Advantageously, the fastening device includes: a first plate, fixedly installed to the upright post and extending parallel to the upright post; a second plate, extending obliquely from the first plate, and the guide shoe is fixedly installed to the second plate.

Advantageously, the second plate extends from the first plate in a direction perpendicular to an elevator hoistway wall.

Advantageously, the first plate is fixedly installed to the upright post by a bolt and abuts against the upright post.

Advantageously, the second plate includes one or more holes, and the guide shoe is fixedly installed to the second plate by inserting bolts into each of the holes.

Advantageously, each of the holes is an elongated hole, and a shape of the elongated hole is designed to extend perpendicular to an extending direction of the second plate, so that a position of the guide shoe can be adjusted upon the guide shoe being installed.

Advantageously, the elevator system further includes a top beam installed to the upright post, and the top beam is able to be installed to the upright post at a first position and a second position under an action of the traction device, wherein the first position corresponds to a final position of the top beam after an elevator is installed, and a distance between the second position and a top of an elevator car is smaller than a distance between the first position and the top of the elevator car.

Advantageously, the upright post includes a first installation feature and a second installation feature, the first installation feature corresponds to a first position of the top beam to fix the top beam in the first position, the second installation feature corresponds to a second position of the top beam to fix the top beam in the second position.

Advantageously, the first installation feature and the second installation feature are in a form of threaded holes.

Advantageously, the fastening device further includes an inclined plate connected between the first plate and the second plate.

### BRIEF DESCRIPTION OF DRAWINGS

The above and other features and advantages of exemplary embodiments of the present disclosure will become more apparent from the following detailed description taken in conjunction with the accompanying drawings, which are for illustrative purposes only and are not intended to limit the scope of the present disclosure in any way, wherein:

FIG. 1 shows a perspective view of a part of an elevator system according to the present disclosure, in which a top beam is in a first position, that is, a final position.

FIG. 2 shows that, during an installation of the elevator system, a top beam moves down to a second position, and a guide shoe is installed to the upright post.

FIG. 3 shows an enlarged view of part A of FIG. 2.

FIG. 4 shows a perspective view of a guide shoe and a fastening device assembled together.

FIG. 5 shows an exploded view of a guide shoe and a fastening device.

FIG. 6 shows a perspective view of a fastening device.

FIG. 7 shows a perspective view of an upright post.

### DETAILED DESCRIPTION

In order to make the purpose, technical details and advantages of the technical solution of the present disclosure more clear, the technical solution of the embodiment of the present disclosure will be described clearly and completely with the accompanying drawings of specific embodiments of the present disclosure. Like reference numerals in the drawings represent like parts. It should be noted that the described embodiment is a part of the embodiment of the present disclosure, not the whole embodiment. Based on the described embodiments of the present disclosure, all other embodiments obtained by ordinary people in the field without creative labor belong to the scope of protection of the present disclosure.

Compared with the embodiment shown in the attached drawings, the feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by people with ordinary skills in the field to which the present disclosure belongs. The words “first”, “second” and similar words used in the specification and claims of the patent application of the present disclosure do not indicate any order, quantity or importance, but are only used to distinguish different components. When the number of parts is not specified, the number of parts can be one or more; similarly, similar words such as “one”, “the” and “said” do not necessarily mean quantity limitation. Similar words such as “including” or “comprising” refer to that the elements or objects appearing before the word cover the elements or objects listed after the word and their equivalents, without excluding other elements or objects. Similar words such as “install”, “set”, “connect” or “connecting” are not limited to physical or mechanical installation, setting and connection, but can include electrical installation, setting and connection, whether directly or indirectly. “Up”, “Down”, “Left” and “Right” are only used to indicate the relative orientation relationship when the equipment is used or the orientation relationship shown in the attached drawings. When the absolute position of the described object changes, the relative orientation relationship may also change accordingly.

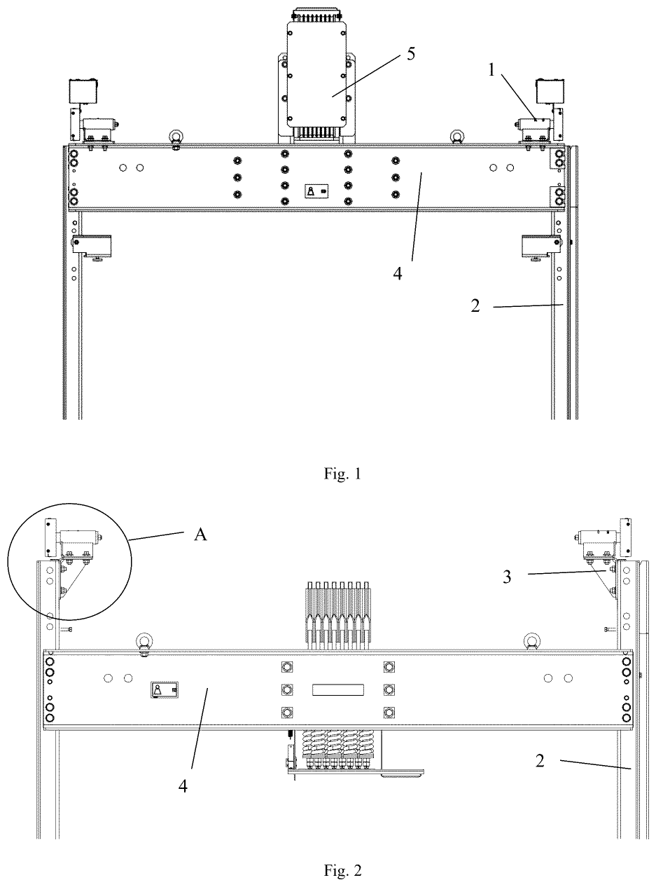

FIG. 1 shows a perspective view of a part of an elevator system, and the elevator has been installed and is in a usable state. In this case, a top beam 4 is in a first position, that is, a final position, and a guide shoe 1 remains fixedly installed to a upright post, and can be engaged with a guide rail (not shown) in the upright post 2.

FIG. 2 shows that, during an installation of the elevator system, the top beam 4 is moved downward to a second position, and the guide shoe 1 is installed to the upright post and can engage the guide rail in the upright post. Thus, the top beam moves downward to the second position, so as to reduce the distance between the top beam and the elevator car, thereby reducing the distance between a traction-type hoist 5 such as Tirak and the elevator car, so that the operator can use a top of the elevator car as a working platform. Because the guide shoe is fixedly installed to the upright post instead of the top beam, the guide shoe can still engage the guide rail when the top beam moves down to the second position.

The first position of the top beam is higher than the second position, and the second position corresponds to a position between the final position of the top beam and the top of the elevator car during elevator installation.

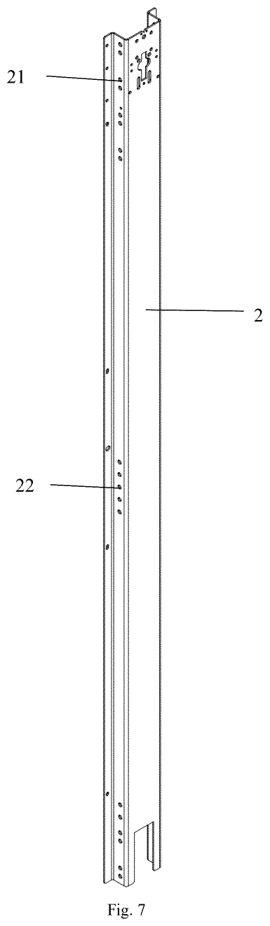

The upright post 2 includes a first installation feature 21 and a second installation feature 22, the first installation feature 21 corresponds to a first position of the top beam to fix the top beam in the first position, and the second installation feature 22 corresponds to a second position of the top beam to fix the top beam in the second position. The first installation feature and the second installation feature are in the form of holes, as shown in FIG. 7. FIG. 7 only schematically shows a schematic number of the first installation feature and the second installation feature. It should be understood by those skilled in the art that the position and number of the first installation feature 21 can be selected as required as long as the final position of the top beam during the use of the elevator system can be met, and the position and number of the second installation feature 22 can also be selected as required as long as the desired second position of the top beam during the installation of the elevator system can be met.

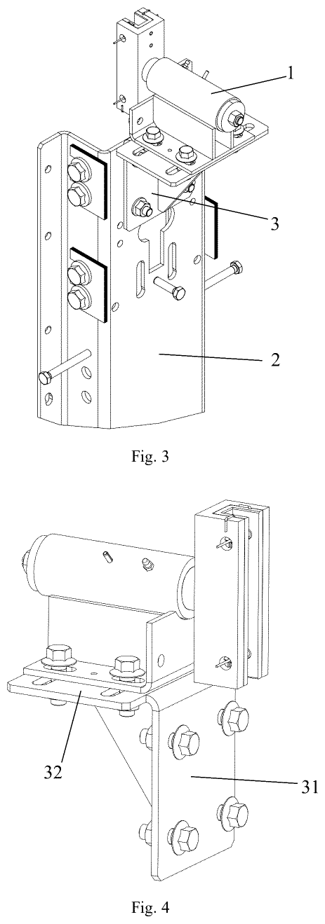

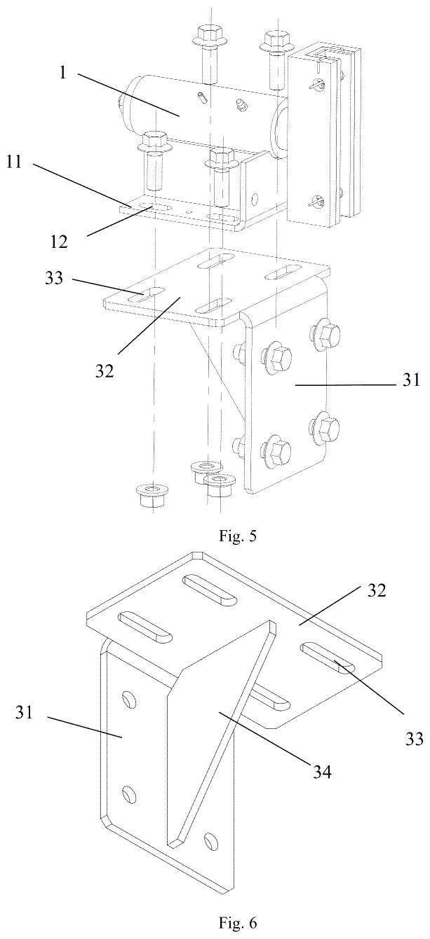

FIGS. 3, 4 and 5 show how the guide shoe 1 is installed to the upright post 2 via a fastening device 3. The fastening device includes a first plate 31, and the first plate 31 is fixedly installed to the upright post by a bolt, for example, and extends parallel to the upright post 2, that is, the first plate 31 extends vertically parallel to the elevator hoistway. The first plate 31 is flat to abut against a lateral surface of the upright post. The second plate 32 of the fastening device 3 extends obliquely from the first plate 31, preferably vertically, and the guide shoe 1 is fixedly installed to this second plate 32.

The second plate 32 includes one or more holes 33, and the guide shoe 1 is fixedly installed to the second plate 32 by inserting a bolt into each of the holes. Preferably, each of the holes is an elongated hole, and a shape of the elongated hole is designed to extend perpendicular to an extending direction of the second plate 32, so that the position of the guide shoe can be adjusted in a direction perpendicular to the extending direction of the second plate when installing the guide shoe.

In the drawings, the guide shoe 1 includes an installation plate 11, and the installation plate also includes one or more elongated holes 12, an extending direction of the elongated hole of the installation plate 11 is perpendicular to the extending direction of the elongated hole of the second plate, and a bolt passes through the respective elongated holes of the installation plate and the second plate, thereby installing the guide shoe to the second plate. In this way, the position of the guide shoe can be adjusted in two directions. However, it should be understood by those skilled in the art that the type of the guide shoe 1 is not important for the present disclosure, and the guide shoe may be any suitable type as long as it is installed to the second plate.

The fastening device also includes an inclined plate 34 connected between the first plate 31 and the second plate 32, and the inclined plate 34 can act as a reinforcing rib.

Through the elevator system provided by the present disclosure, the position of the top beam can be lowered during the installation of the elevator system, and the top of the elevator car can be used as a working platform, so that the demand for an additional working platform is saved; and meanwhile, the guide shoe is installed on the upright post instead of the top beam, so that the joint between the guide shoe and the guide rail can still be ensured without hindering the function of the guide shoe.

Although the present disclosure has been described in the specification and illustrated in the drawings on the basis of referring to various embodiments, those skilled in the art can understand that the above-mentioned embodiments are only preferred embodiments, and some technical features in the embodiments may not be necessary for solving specific technical problems, so these technical features may not be needed or omitted without affecting the solution of technical problems or the formation of technical solutions; Moreover, the features, elements and/or functions of one embodiment can be combined, combined or coordinated with those of one or more other embodiments as appropriate, unless the combination, combination or coordination is obviously impracticable.

1. An elevator system, comprising:
an upright post, extending vertically along an elevator hoistway and accommodating a guide rail; and
a guide shoe, for engaging the guide rail,
which is characterized in that, during an installation of the elevator system via a traction device, the guide shoe is temporarily installed to the upright post via a fastening device to engage the guide rail.

2. The elevator system according to claim 1, wherein the fastening device comprises:
a first plate, fixedly installed to the upright post and extending parallel to the upright post;
a second plate, extending obliquely from the first plate, and the guide shoe is fixedly installed to the second plate.

3. The elevator system according to claim 2, wherein the second plate extends from the first plate in a direction perpendicular to an elevator hoistway wall.

4. The elevator system according to claim 2, wherein the first plate is fixedly installed to the upright post by a bolt and abuts against the upright post.

5. The elevator system according to claim 2, wherein the second plate comprises one or more holes, and the guide shoe is fixedly installed to the second plate by inserting bolts into each of the holes.

6. The elevator system according to claim 5, wherein each of the holes is an elongated hole, and a shape of the elongated hole is designed to extend perpendicular to an extending direction of the second plate, so that a position of the guide shoe can be adjusted upon the guide shoe being installed.

7. The elevator system according to claim 1, wherein the elevator system further comprises a top beam installed to the upright post, and the top beam is able to be installed to the upright post at a first position and a second position under an action of the traction device, wherein the first position corresponds to a final position of the top beam after an elevator is installed, and a distance between the second position and a top of an elevator car is smaller than a distance between the first position and the top of the elevator car.

8. The elevator system according to claim 7, wherein the upright post comprises a first installation feature and a second installation feature, the first installation feature corresponds to a first position of the top beam to fix the top beam in the first position, the second installation feature corresponds to a second position of the top beam to fix the top beam in the second position.

9. The elevator system according to claim 8, wherein the first installation feature and the second installation feature are in a form of threaded holes.

10. The elevator system according to claim 2, wherein the fastening device further comprises an inclined plate connected between the first plate and the second plate.
